(19) United States
(12) Patent Application Publication
(10) Pub. No.: US 2018/0054863 A1
(43) Pub. Date: Feb. 22, 2018

(54) Solid State Lighting Driver Circuit with Ballast Compatibility

(71) Applicants: Dialog Semiconductor (UK) Limited, London (GB); Dialog Semiconductor Inc., Campbell, CA (US)

(72) Inventors: Ye Hu, Guangdong (CN); Gordon Chen, Campbell, CA (US); Baorong Chen, Guangdong (CN); Liang Yan, Shanghai (CN)

(21) Appl. No.: 15/802,925

(22) Filed: Nov. 3, 2017

Related U.S. Application Data
(63) Continuation of application No. PCT/CN2015/079946, filed on May 27, 2015.

(51) Int. Cl. H05B 33/08; H02M 1/32

(52) U.S. Cl. CPC H05B 33/0818; H02M 2001/0003; H02M 1/32

(57) ABSTRACT

A solid state lighting driver circuit containing an input for connection with a ballast; an output for driving a light emitting element; and a switch is provided. The switch is selectively operable to transition between a first state providing a low impedance path for a ballast output and a second state where the ballast output drives the output. A solid state lighting driver circuit has a switch connected across its input that selectively drives the circuit with a ballast output, or provides a low impedance path for the ballast output so that the ballast goes into self-protection mode. This means that the driver circuit is compatible with an electronic ballast but is well regulated. Also, a method controlling a solid state lamp for selectively driving a load with a ballast or providing a low impedance path for a ballast output is presented.

This application is a Continuation of: PCT application number PCT/CN2015/079946, Filed May 27, 2015, which is owned by common assignees and is herein incorporated by reference in its entirety.

### TECHNICAL FIELD

The present disclosure relates to a driver circuit for solid state lighting that is compatible with a ballast, in particular with an electronic ballast.

### BACKGROUND

Solid state lamps are gaining popularity as compared with older incandescent or fluorescent lamps due to their increased efficiency. A solid state lamp comprises a light emitting element and a driver circuit that is designed to provide the correct level of power to the lighting element so that it provides a sufficient light output yet is not damaged due to too much power being provided. A lamp is usually provided in a bulb housing and includes the driver circuit and the light emitting element. One type of solid state lamp employs a light emitting diode (LED) as its light emitting element.

A ballast is a device or circuit which limits the amount of current supplied to a load. They are commonly used in devices which exhibit a negative resistance characteristic such as gas discharge lamps, where limiting the current is important to prevent the lamp being destroyed or failing. However, ballasts are also useful for limiting the current in ordinary positive resistance circuits, including for use with solid state lamps. The ballast is usually integrated with a luminaire housing, for coupling with the driver circuit of a solid state lamp via suitable electrical connectors when the solid state lamp is inserted into a socket of a luminaire housing. Magnetic ballasts include inductors which provide reactance to the electrical current provided to a circuit. They operate at a frequency that is similar to that of the mains frequency. Electronic ballasts employ solid state circuits and are often based on switched mode power supply topology, rectifying the input power and chopping it at high frequency. An electronic ballast may allow dimming by techniques such as pulse width modulation. An electronic ballast usually supplies power to a lamp at several tens of kilohertz.

As shown in FIG. 1, a solid state lighting system 100 comprises an electronic ballast 102, solid state lamp driver circuit 104 and a solid state lamp 106. The lighting system 100 is powered by the AC mains supply 108 provided by an external electrical grid (although it could equally be powered by an off-grid supply such as a generator). It is to be appreciated that FIG. 1 is for schematic and illustrative purposes only and a lighting system may comprise a plurality of solid state lamps 106 which may be driven by a common driver circuit 104 or which may each be provided with their own individual driver circuit 104. Also, while the ballast 102, driver 104 and lamp 106 are illustrated as separate functional components it is to be appreciated all or some of the components may be combined in a common circuit.

The lighting system 100 may comprise a luminaire which has a housing and a socket for receiving a lamp. Typically for the case of solid state lamps, a lamp body houses the light emitting element and the driver circuit, while a ballast will normally be provided as part of the luminaire into which the lamp is inserted.

When using a ballast to control a lamp, the current must be properly regulated and the power between the input and output of the ballast must be balanced. There is a need to improve the design of a lighting system to achieve better control and reliability when used with ballasts. There is also a need to ensure compatibility of solid state lamps with a range of luminaires, which may have ballasts not specifically designed for use with solid state lamps. For example, replacing a gas discharge tube lamp with a solid state equivalent is often not possible because the ballast in a luminaire is designed for use with gas discharge lamps and is incompatible with solid state lamps.

Ballasts are often found to operate by self-oscillating method, or controlled by integrated circuits. After ignition, its output current is limited by ballast itself. So typically the ballast becomes a current source to the driver.

Lamps are usually required to have consistent luminosity values. Due to the variation of ballast types, circuits and manufacturing variation, there are wide variations of load current if a ballast is relied upon to provide current to a solid state lamp directly. Therefore, LED drivers are often required to output a regulated current. The LED driver, in this sense, can be considered a regulated current sink. The mismatch of input (ballast output as current source) and output (LED driver load as current sink) can cause large variation of bus voltage. This may even cause circuit failure if not controlled.

### SUMMARY

According to a first aspect of the present disclosure there is provided a solid state lighting driver circuit comprising: an input for connection with a ballast; an output for driving a light emitting element; and a switch which is selectively operable to transition between a first state providing a low impedance path for a ballast output and a second state where the ballast output drives the output.

The low impedance path may comprise a path to ground, or a reference voltage.

Optionally, the switch is provided across the input.

Optionally, the switch is operable to pulse width modulate the coupling of the ballast with the output.

Optionally, regulation circuitry is provided for regulating the load.

Optionally, the regulation circuitry comprises a current sense element and a switch operable to control output current of the light emitting element.

Optionally, the solid state lighting driver circuit comprises a controller arranged to control operation of the switch and/or the regulation circuitry.

Optionally, the controller provides overvoltage protection.

Optionally, the controller provides overcurrent protection.

Optionally, the controller balances input and output power.

Optionally, the controller provides a dimming function.

The solid state lighting driver circuit of the first aspect may incorporate other features as substantially described herein.

According to a second aspect of the present disclosure there is provided a solid state lamp comprising: a light emitting element; and a solid state lighting driver circuit comprising: an input for connection with a ballast; an output for driving a light emitting element; and a switch which is selectively operable to transition between a first state providing a low impedance path for a ballast output and a second state where the ballast output drives the output.

The solid state lamp of the second aspect may incorporate any features of the first aspect and other features as substantially described herein.

According to a third aspect of the present disclosure there is provided a method controlling a solid state lamp comprising selectively driving a load with a ballast or providing a low impedance path for a ballast output.

The method of the third aspect may also comprise providing, implementing or using the features described in the first or second aspects, and also various steps and methods as described herein.

### BRIEF DESCRIPTION OF THE DRAWINGS

The disclosure will now be described, by way of example only, with reference to the accompanying drawings in which:

FIG. 1 illustrates a generic lighting system;

FIG. 2 illustrates an LED driver circuit which works with an electronic ballast input;

FIG. 3 illustrates a modification of the circuit of FIG. 2 in which a controller is provided to sense the input voltage and regulate the load current;

FIG. 4 illustrates a further modification in which the input impedance is adjusted to change the ballast operating frequency;

FIG. 5 illustrates an embodiment of the disclosure in which a switching element is provided across an LED driver input;

FIG. 6 illustrates a further embodiment of the disclosure in which the load is regulated;

FIG. 7 illustrates a further embodiment of the disclosure in which a controller is provided for operation of a switching element across an LED driver input and a switching element that regulates the load;

FIG. 8 illustrates a further embodiment of the disclosure in which a controller is provided for overvoltage protection;

FIG. 9 illustrates a further embodiment of the disclosure in which a controller is provided for overcurrent protection for an unregulated driver;

FIG. 10 illustrates a conceptual design for the balancing the power between input and output of the driver circuit;

FIG. 11 shows dimming with a regulated load; and

FIG. 12 shows dimming with an unregulated load.

### DESCRIPTION

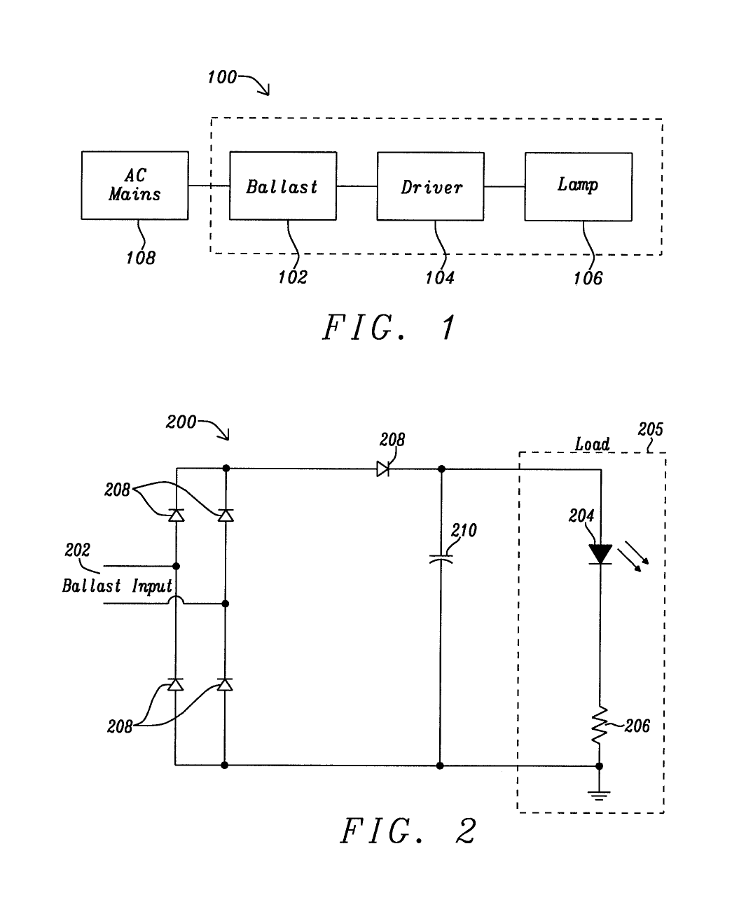

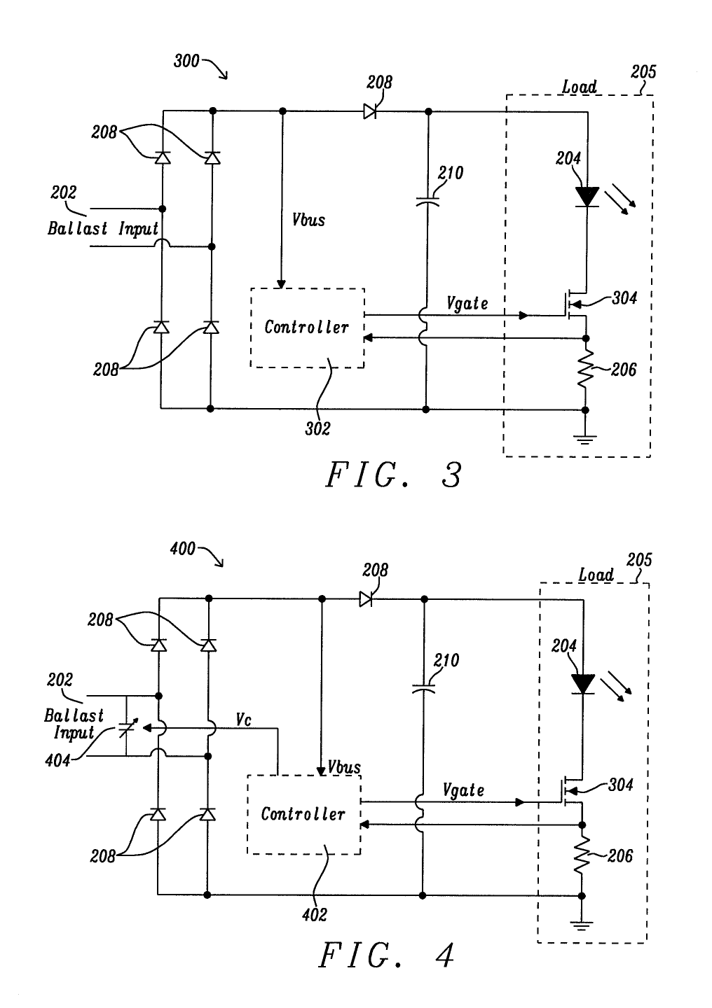

FIG. 2 shows an LED driver circuit 200 arranged to receive a ballast input 202 and to regulate current delivered to solid state lamp, in this case an LED 204. The ballast input 202 is rectified by diodes 208, and a capacitor 210 is provided for energy storage. The load 205 provided by LED 204 and resistor 206 is unregulated. Its current depends on the operation status of the ballast and can vary widely. Here (and in other embodiments that provided regulated loads), the resistor 206 acts as a current limiter.

FIG. 3 shows an alternative LED driver circuit 300, in which the load is regulated. It shares common components with the circuit of FIG. 2, so the same reference numerals have been used again. Since the ballast is a current source there is a large variation of the voltage VBUS after the rectifier if the input and output energy are not balanced. A controller 302 is used to sense VBUS and regulate the load current such that VBUS is controlled to stay within a defined safe range. Regulation of the load current is achieved by monitoring and controlling the gate voltage (VGATE) of a switching element 304 which selectively couples the LED 204 with the resistor 206, which here acts as a current sense element. Alternative current sensing elements may be used. The figure shows an NMOS FET although any suitable switching element could be chosen according to the system architecture. Compared with the driver circuit 200 of FIG. 2, this circuit 300 can control the load current within a smaller range. The load current is therefore loosely regulated.

FIG. 4 shows a further alternative LED driver circuit 400. Again, reference numerals from previous diagrams are re-used when describing the same components. The controller 402 is similar to the controller 302 shown in FIG. 3, except that it is arranged to adjust the operational frequency of the ballast such that the input power from the ballast can match the load current. In this embodiment this is achieved by means of a control signal VC which is sent to a variable capacitor 404 that modifies the ballast input 202, although other suitable mechanisms may be used. The load current of this circuit 400 is therefore tightly regulated.

FIGS. 2 to 4 illustrate various LED driver circuits which are compatible with ballasts. In particular, the driver circuit 400 of FIG. 4 achieves tight LED current regulation and balance between input and output powers of the circuit 400. However even this improved circuit has some drawbacks. It has a high cost because adjusting the input impedance requires complicated circuitry and control techniques. Also, its capability to dim the output of the light is limited, as it is hard to adjust the impedance of the ballast input by a large enough amount to apply a large amount of dimming. Furthermore, it is not able to provide protection in case of circuit failure.

It is therefore desirable to provide a driver circuit for solid state lamp that overcomes or ameliorates these disadvantages, or which provides other general improvements.

FIG. 5 illustrates an embodiment of a solid state driver circuit which has been designed to address these problems. This circuit 500 receives an input 202 from an electronic ballast 502, and drives a load 205 comprising one or more solid state lamps 204.

In addition, a switch 502 is provided either directly or effectively across the input of the driver circuit.

The switch 502 can be selectively operated to control the coupling of the ballast input 202 with the load 205. In a first state (on), a low impedance path is provided for the output of the ballast, and the voltage after the rectifier VBUS is shorted to ground. The ballast operates in a self-protection mode. One of the rectifying diodes 208 (D1) blocks the current flow back to the input, and power is supplied to the load from the energy storage element 210, which is normally a capacitor. The current supplied to the load can be tightly regulated and the load supply voltage VC1 will reduce over time.

When the switch 502 changes to a second state (off, as shown in FIG. 5), normal ballast operation is recovered. Input power is transferred to the load 205 through the rectifying diodes 208 including D1. The load supply voltage VC1 increases during this time.

The switch 502 is operated by a control signal VG_Q1, the timing of which can be chosen to regulate the power supplied to the load, that is, the output power.

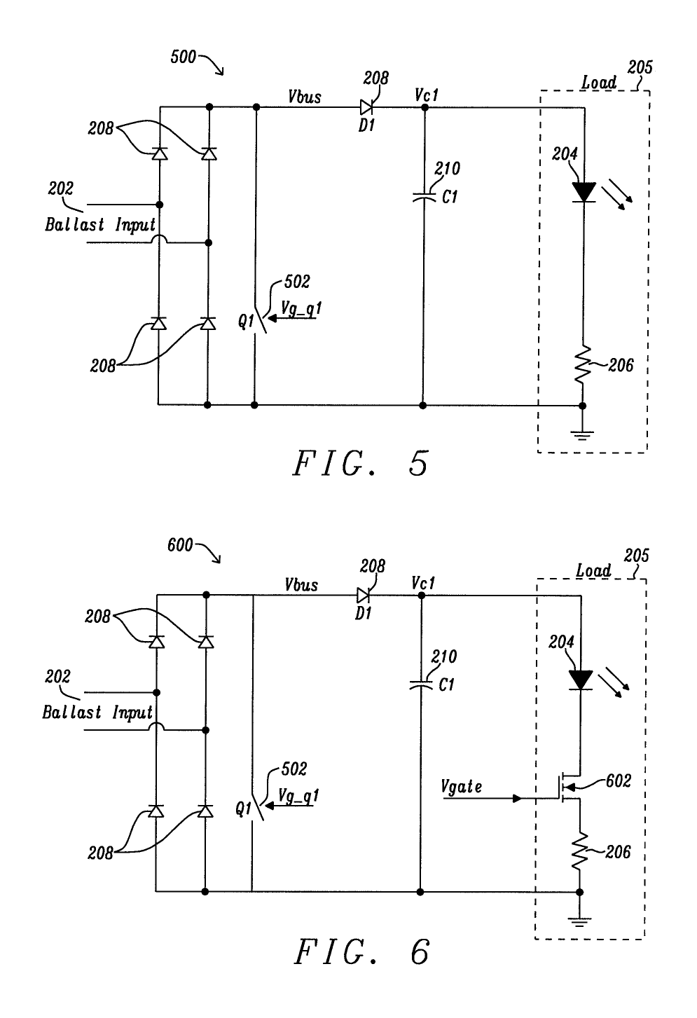

FIG. 6 shows an embodiment of an LED driver circuit 600 which includes regulation of the load, with appropriate regulation circuitry. In this embodiment the regulation circuitry comprises a switching element 602 that operates in a similar fashion to the switching element 304 previously shown in FIG. 3. It selectively couples the LED 204 with the current sensor (which here takes the form of a resistor 206). The figure shows an NMOS FET but the switching element 602 may be any suitable element. The switching element 602 is controlled by a control signal VGATE, which changes the gate voltage to control current flow between the drain and source of the switching element 602.

If the ballast acts as a pure current source then an unregulated driver circuit 500 according to the embodiment of FIG. 5 would be suitable. However some electronic ballasts have voltage characteristics so controlling the VGATE signal using the driver circuit 600 of the embodiment of FIG. 6 can be useful in such circumstances.

When the switch 502 is being controlled VGATE can be left on and the load 205 does not have to be regulated. On the other hand when the switch 502 is off then VGATE can be controlled to adjust the load.

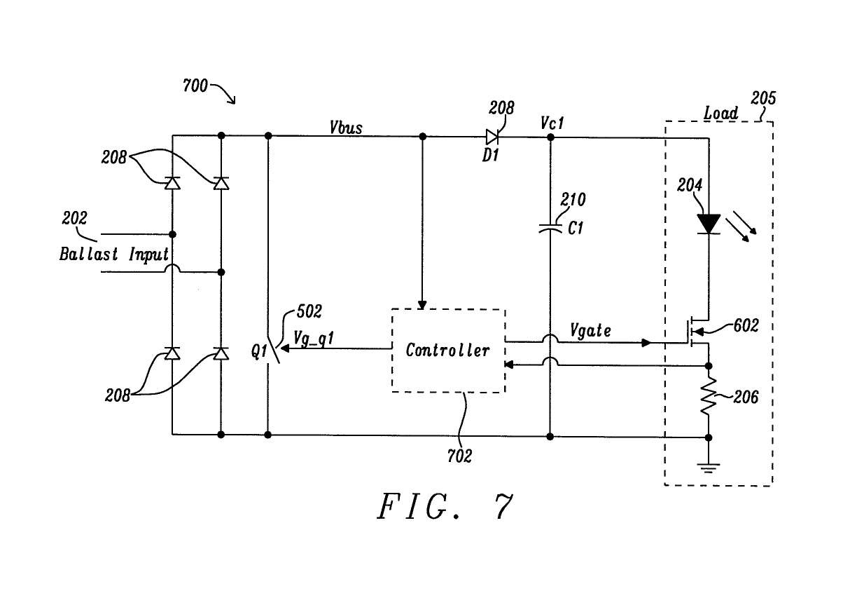

FIG. 7 illustrates a further embodiment of an LED driver circuit 700 according to the disclosure. This corresponds in part to the embodiment of FIG. 6 so the same reference numerals shall be used where appropriate. However in this embodiment a controller 702 is provided. This controller 702 can provide integral control for the VG_Q1 and VGATE signals, and can provide additional functionality such as over voltage protection and over current protection and dimming functionality, or combination of these, as well as any general additional control that may be desired.

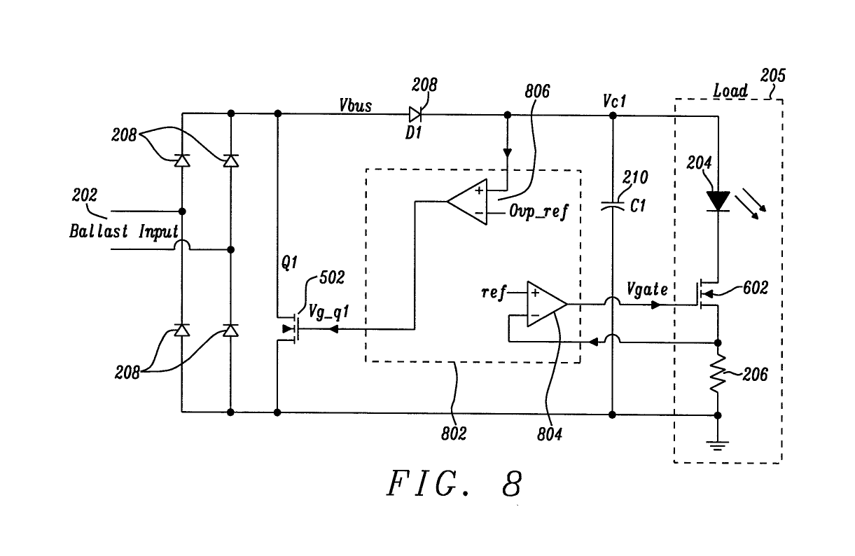

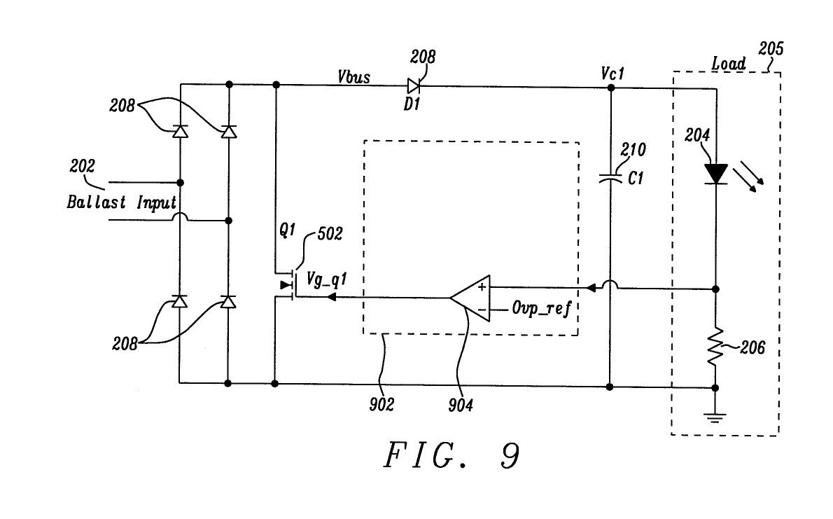

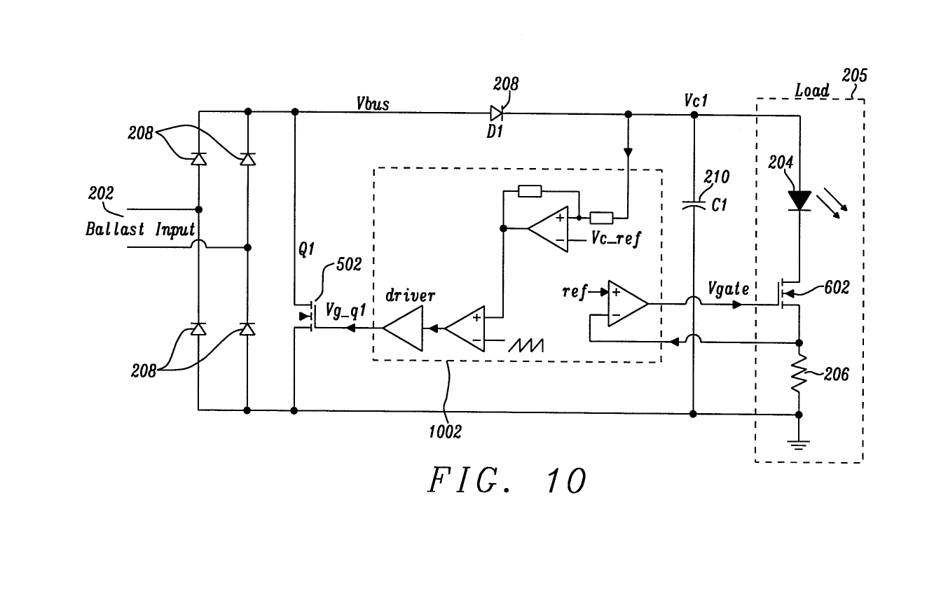

Different example controllers are shown in FIGS. 8 through 12. In the embodiment of FIG. 8, the controller 802 provides over voltage protection. Comparators 804 and 806 compare the driver circuit input voltage at node VC1 and output voltage VGATE with reference voltages such that, if VC1 is higher than a defined over voltage protection threshold, the switch 502 is turned on so that the ballast goes in to self-protection mode. This prevents the ratio of VBUS to VC1 being too high and damaging the circuit. Here (and in FIGS. 9 to 12), the switch 502 is illustrated as a MOSFET but it may be any other type of device such as a different kind of FET or a BJT.

FIG. 9 shows an embodiment where a controller 902 provides for over current protection of an unregulated driver circuit. If a high power ballast is connected with a low current LED load, there is a risk that the load current can be high enough to damage the circuit. If the current through the LED goes above a defined safety limit, the switch 502 is switched on to prevent damage to the load. The sense resistor 206 converts the load current to a voltage signal. A comparator 904 compares the voltage signal with a reference voltage which defines or is related to the safety limit.

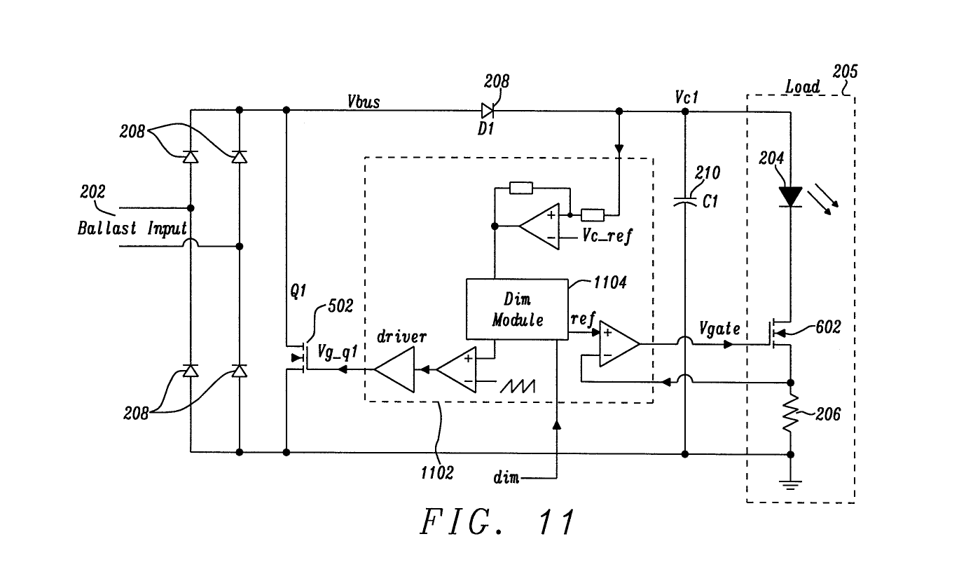

FIG. 10 illustrates an embodiment with load regulation, wherein the controller 1002 provides regulation of the input to output voltage ratio VBUS to VC1. The output voltage VC1 is sensed and compared with the reference voltage VCREF. A compensator is included set the correct PWM duty cycle levels. The switch 502 operates under PWM mode with the duty cycle controlled such that VC1 is regulated tightly. This method has the benefit of providing an appropriate voltage overhead for switch 602 in order to minimise power loss and achieve good efficiency.

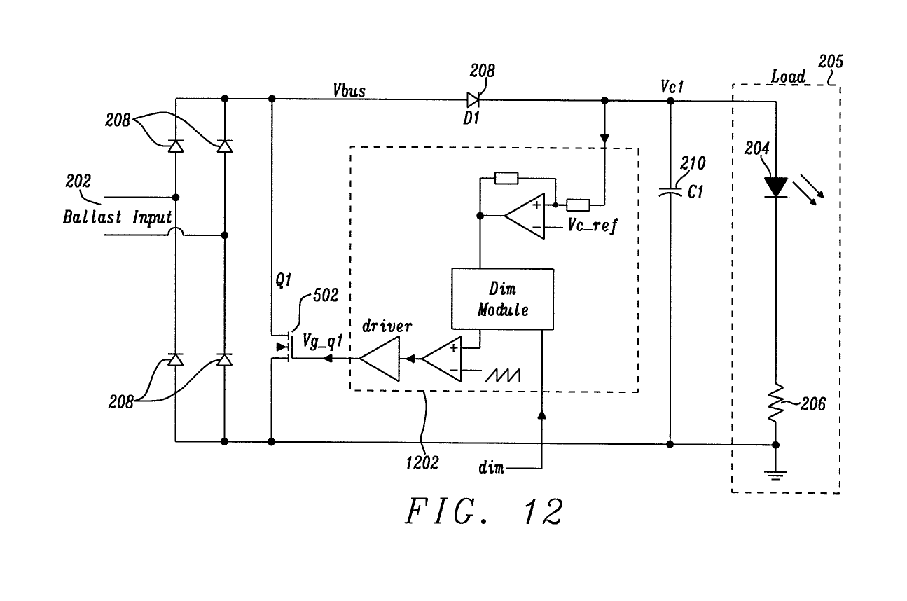

FIG. 11 illustrates another design providing a controller 1102 which incorporates a dimming function, utilising a dimming module 1104. The dimming module 1104 further adjusts the duty cycle of switch 502 based upon dimming requirements. When dimming is required, the current reference voltage reduces. In the meantime the duty cycle of the switch 502 is increased based upon either the VC1 voltage, or directly from the dimming signal in order to speed up the response.

FIG. 12 illustrates another design, in which a controller 1202 provides a dimming function. This LED load 205 is unregulated. In this case, the duty cycle of switch 502 is directly correlated with the dimming signal. When dimming function is needed, the duty cycle of switch 502 increases to reduce power provided to the load 205.

It is to be appreciated that the functions shown in the controllers of FIGS. 8 to 12 could be combined. For example, a controller may provide a dimming function in addition to any one or more of overvoltage protection, overcurrent protection, and power balancing. In general any combination of these functions can be provided.

Various improvements and modifications can be made to the above without departing from the scope of the disclosure.

What is claimed is:

1. A solid state lighting driver circuit comprising:
an input for connection with a ballast;
an output for driving a light emitting element; and
a switch which is selectively operable to transition between a first state providing a low impedance path for a ballast output and a second state where the ballast output drives the output.

2. The solid state lighting driver circuit of claim 1, wherein the switch is provided across the input.

3. The solid state lighting driver circuit of claim 1, wherein the switch is operable to pulse width modulate the coupling of the ballast with the output.

4. The solid state lighting driver circuit of claim 1, wherein regulation circuitry is provided for regulating the load.

5. The solid state lighting driver circuit of claim 4, wherein the regulation circuitry comprises a current sense element and a switch operable to control output current of the light emitting element.

6. The solid state lighting driver circuit of claim 4, comprising a controller arranged to control operation of the switch and/or the regulation circuitry.

7. The solid state lighting driver circuit of claim 6, wherein the controller provides overvoltage protection.

8. The solid state lighting driver circuit of claim 6, wherein the controller provides overcurrent protection.

9. The solid state lighting driver circuit of claim 6, wherein the controller balances input and output power.

10. The solid state lighting driver circuit of claim 6, wherein the controller provides a dimming function.

11. A solid state lamp comprising:
a light emitting element; and
a solid state lighting driver circuit comprising:
an input for connection with a ballast;
an output for driving a light emitting element; and
a switch which is selectively operable to transition between a first state providing a low impedance path for a ballast output and a second state where the ballast output drives the output.

12. A method of controlling a solid state lamp comprising selectively driving a load with a ballast or providing a low impedance path for a ballast output.
